(19) United States
(12) Patent Application Publication
(10) Pub. No.: US 2009/0143218 A1
(43) Pub. Date: Jun. 4, 2009

(54) REGENERATION PROCESS FOR A C8 ALKYLAROMATIC ISOMERIZATION CATALYST

(76) Inventors: Paula L. Bogdan, Mount Prospect, IL (US); Gregory F. Maher, Aurora, IL (US); John E. Bauer, LaGrange Park, IL (US); Patrick C. Whitchurch, Bossier City, LA (US)

Correspondence Address: HONEYWELL INTERNATIONAL INC;PATENT SERVICES, 101 COLUMBIA DRIVE, P O BOX 2245 MAIL STOP AB/2B, MORRISTOWN, NJ, 07962, US

(21) Appl. No.: 11/949,076

(22) Filed: Dec. 3, 2007

(51) Int. Cl. B01J 38/18

(52) U.S. Cl. 502/37

(57) ABSTRACT

One exemplary embodiment can be a regeneration process for a C8 alkylaromatic isomerization catalyst. The process can include:

contacting the C8 alkylaromatic isomerization catalyst with a first gas stream comprising an oxidizing gas at a first stage for a first time period and a first temperature effective to remove at least a portion of a carbonaceous material from the C8 alkylaromatic isomerization catalyst; and

contacting the C8 alkylaromatic isomerization catalyst with a second gas stream comprising the oxidizing gas at a second stage for a second time period and a second temperature effective to remove another portion of the carbonaceous material from the C8 alkylaromatic isomerization catalyst.

### FIELD OF THE INVENTION

The field of this invention generally relates to a regeneration process for a catalyst for a C8 aromatic isomerization process.

### BACKGROUND OF THE INVENTION

Xylenes, such as para-xylene, meta-xylene and ortho-xylene, can be important intermediates that find wide and varied application in chemical syntheses. However, xylenes from catalytic reforming or other sources generally do not match demand proportions as chemical intermediates, and further comprise ethylbenzene, which can be difficult to separate or to convert. Typically, para-xylene is a major chemical intermediate with significant demand, but amounts to only about 20- about 25%, by weight, of a typical C8 aromatic stream. Adjustment of an isomer ratio to demand can be effected by combining xylene-isomer recovery, such as adsorption for para-xylene recovery, with isomerization to yield an additional quantity of the desired isomer. Typically, isomerization converts a non-equilibrium mixture of the xylene isomers that is lean in the desired xylene isomer to a mixture approaching equilibrium concentrations.

Various catalysts and processes have been developed to effect xylene isomerization. Generally, after a given period of time, the catalyst can become spent and require regeneration. There are many processes that can be utilized to regenerate catalyst. Typically, the process involves heating the catalyst in an oxidizing gas to burn carbonaceous material deposited on the catalyst. Generally, it is desirable to have a regenerated catalyst having the same activity as fresh catalyst. For some types of catalysts, this goal can be elusive. If conditions are too severe, the regenerated catalyst may have excessive xylene isomerization activity and generate excessive byproducts, such as toluene and C9 aromatic compounds. If conditions are insufficient, the regenerated catalyst may be ineffective. Moreover, regeneration can be challenging due to the presence of steam at elevated temperatures that can result in hydrothermal damage to the zeolite structure impacting the number, strength and accessibility of acid sites.

Accordingly, it is desirable to regenerate a C8 alkylaromatic isomerization catalyst to the desired activity after regeneration.

### BRIEF SUMMARY OF THE INVENTION

One exemplary embodiment can be a regeneration process for a C8 alkylaromatic isomerization catalyst. The process can include:

contacting the C8 alkylaromatic isomerization catalyst with a first gas stream including an oxidizing gas at a first stage for a first time period and a first temperature effective to remove at least a portion of a carbonaceous material from the C8 alkylaromatic isomerization catalyst; and

contacting the C8 alkylaromatic isomerization catalyst with a second gas stream including the oxidizing gas at a second stage for a second time period and a second temperature effective to remove another portion of the carbonaceous material from the C8 alkylaromatic isomerization catalyst.

The C8 alkylaromatic isomerization catalyst can include:

about 1- about 90%, by weight, of a molecular sieve where the molecular sieve can include at least one of an MTW zeolite, an MFI zeolite, a mordenite zeolite and an ATO non-zeolite sieve, where each zeolite may have a silica to alumina mole ratio less than about 45:1;

about 10- about 99%, by weight, of a binder; and

about 0.1- about 2%, by weight, of a noble metal, calculated on an elemental basis.

Another exemplary embodiment can be a regeneration process for a C8 alkylaromatic isomerization catalyst. The process can include:

contacting the C8 alkylaromatic isomerization catalyst with a first gas stream including an oxidizing gas at a first stage at a temperature of about 245- about 500° C. effective to remove at least a portion of the carbonaceous material from the C8 alkylaromatic isomerization catalyst;

contacting the C8 alkylaromatic isomerization catalyst with a second gas stream including the oxidizing gas at a second stage at a temperature of about 350- about 500° C. effective to remove another portion of the carbonaceous material from the C8 alkylaromatic isomerization catalyst; and

removing a total amount of at least about 75%, by weight, of the carbonaceous material.

The C8 alkylaromatic isomerization catalyst can include:

about 1- about 90%, by weight, of at least one of an MTW zeolite, an MFI zeolite, a mordenite zeolite, and an MgAPSO-31 non-zeolite molecular sieve, where each zeolite may have a silica to alumina mole ratio less than about 45:1;

about 10- about 99%, by weight, of a binder; and

about 0.1- about 2%, by weight, of a noble metal, calculated on an elemental basis.

A further exemplary embodiment is a regeneration process for a C8 alkylaromatic isomerization catalyst. The process can include:

contacting the C8 alkylaromatic isomerization catalyst with a first gas stream including an oxidizing gas at a first stage at a temperature of about 245- about 500° C. effective to remove at least a portion of a carbonaceous material from the C8 alkylaromatic isomerization catalyst;

contacting the C8 alkylaromatic isomerization catalyst with a second gas stream including the oxidizing gas at a second stage at a temperature of about 350- about 500° C. effective to remove another portion of the carbonaceous material from the C8 alkylaromatic isomerization catalyst;

reducing the C8 alkylaromatic isomerization catalyst; and

sulfiding the C8 alkylaromatic isomerization catalyst.

The C8 alkylaromatic isomerization catalyst may include:

about 1- about 90%, by weight, of at least one of an MTW zeolite, an MFI zeolite, a mordenite zeolite, and an ATO non-zeolite sieve, where each zeolite may have a silica to alumina mole ratio less than about 45:1;

about 10- about 99%, by weight, of a binder; and

about 0.1- about 2%, by weight, of a noble metal, calculated on an elemental basis.

Therefore, a regeneration process of effective severity can provide a regenerated catalyst with an activity similar to fresh catalyst for xylene and ethylbenzene isomerization and C8 ring loss.

### DEFINITIONS

As used herein, the term “zone” can refer to an area including one or more equipment items and/or one or more sub-zones. Equipment items can include one or more reactors or reactor vessels, heaters, separators, exchangers, pipes, pumps, compressors, and controllers. Additionally, an equipment item, such as a reactor or vessel, can further include one or more zones or sub-zones.

As used herein, the term “stream” can be a stream including various hydrocarbon molecules, such as straight-chain, branched, or cyclic alkanes, alkenes, alkadienes, and alkynes, and optionally other substances, such as gases, e.g., hydrogen, or impurities, such as heavy metals. The stream can also include aromatic and non-aromatic hydrocarbons. Moreover, the hydrocarbon molecules may be abbreviated C1, C2, C3 ... Cn where “n” represents the number of carbon atoms in the hydrocarbon molecule.

As used herein, the term “aromatic” can mean a group containing one or more rings of unsaturated cyclic carbon radicals where one or more of the carbon radicals can be replaced by one or more non-carbon radicals. An exemplary aromatic compound is benzene having a C6 ring containing three double bonds. Other exemplary aromatic compounds can include para-xylene, ortho-xylene, meta-xylene and ethylbenzene. Moreover, characterizing a stream or zone as “aromatic” can imply one or more different aromatic compounds comprised in a stream or zone.

As used herein, the term “support” generally means a molecular sieve that has been combined with a binder before the addition of one or more additional catalytically active components, such as a noble metal, or subjected to a subsequent process such as reducing or sulfiding.

### DETAILED DESCRIPTION OF THE INVENTION

The regeneration process disclosed herein can provide a low inlet and catalyst bed temperature during the primary carbon removal stage. In addition, low water concentration can aid the catalyst regeneration. Moreover, sufficient yet regulated halogen injection can maintain the dispersion of at least one noble metal while limiting residual halogen at the completion of the procedure. Desirably, about 0.05%- about 0.5%, by weight, carbon may remain on the catalyst after the regeneration, based on the weight of the catalyst. The amount of carbon on the catalyst can be determined by UOP Method 703-98. The regeneration process can be utilized for a variety of catalysts.

A typical catalyst regenerated by the process disclosed herein can include a zeolite or a non-zeolite molecular sieve. The molecular sieve can be at least one of an MTW zeolite, an MFI zeolite, a mordenite zeolite, and an ATO non-zeolite sieve. Exemplary MFI and MTW zeolites are disclosed in U.S. Pat. No. 3,856,871, an exemplary mordenite zeolite is disclosed in U.S. Pat. No. 6,465,705 B1, and an exemplary ATO non-zeolite sieve, such as an MgAPSO-31 non-zeolite sieve, is disclosed in U.S. Pat. No. 4,758,419. Desirably, the zeolites can have a silica to alumina mole ratio less than about 45:1, desirably from about 20:1- about 40:1. Typically, the MgAPSO-31 non-zeolite sieve can have an Si/Al₂ mole ratio of about 0.01:1- about 0.5:1, preferably about 0.01:1- about 0.03:1.

The molecular sieve can be composited with a binder for forming a catalyst support. Generally, the proportion of the molecular sieve in the catalyst is about 1- about 90%, by weight, desirably about 2- about 20%, by weight, with the remainder optionally being one or more metal and other components along with a binder, as discussed herein.

Generally, the binder is a porous, adsorptive support having a surface area of about 25- about 500 m²/g. Desirably, the binder can be: (1) a refractory inorganic oxide such as an alumina, a titania, a zirconia, a chromia, a zinc oxide, a magnesia, a thoria, a boria, a silica-alumina, a silica-magnesia, a chromia-alumina, an alumina-boria, a silica-zirconia, or a phosphorus-alumina; (2) a ceramic, a porcelain, or a bauxite; (3) a silica or silica gel, a silicon carbide, a synthetically prepared or naturally occurring clay or silicate, optionally acid treated, as an example, an attapulgite clay, a diatomaceous earth, a fuller's earth, a kaolin, or a kieselguhr; (4) a naturally occurring or synthetically prepared crystalline zeolitic aluminosilicate, such as FAU, MEL, MFI, MOR, MTW (IUPAC Commission on Zeolite Nomenclature), in hydrogen form or in a form which has been exchanged with one or more metal cations, (5) an aluminophosphate; (6) a spinel such as MgAl₂O₄, FeAl₂O₄, ZnAl₂O₄, CaAl₂O₄, or another similar compound having a formula MOAl₂O₃ where M is a metal having a valence of 2; or (7) a combination of materials from one or more of these groups.

A desired refractory inorganic oxide can be alumina. A suitable alumina material is a crystalline alumina known as the gamma-, eta-, or theta-alumina, with gamma- or eta-alumina being preferred.

In one exemplary embodiment, the catalyst can be an extrudate. Generally, the extrusion initially involves mixing of the molecular sieve with optionally the binder and a suitable peptizing agent to form a homogeneous dough or thick paste having the correct moisture content to allow for the formation of an extrudate with acceptable integrity to withstand direct calcination. Extrudability may be determined from an analysis of the moisture content of the dough, with a moisture content in the range of from about 30- about 70%, by weight, being preferred. The dough may then be extruded through a die pierced with multiple holes and the spaghetti-shaped extrudate can be cut to form particles in accordance with known techniques. A multitude of different extrudate shapes is possible, including a cylinder, cloverleaf, dumbbell, and symmetrical and asymmetrical polylobates. Furthermore, the dough or extrudate may be shaped to any desired form, such as a sphere, by, e.g., marumerization that can entail one or more moving plates or compressing the dough or extrudate into molds.

An alternative shape of the catalyst may be a sphere continuously manufactured by a well-known oil drop method. Generally, preparation of alumina-bound spheres involves dropping a mixture of molecular sieve, alsol, and gelling agent into an oil bath maintained at elevated temperatures. Examples of gelling agents that may be used in this process include hexamethylene tetraamine, urea, and mixtures thereof. The gelling agents can release ammonia at the elevated temperatures which sets or converts the hydrosol spheres into hydrogel spheres. The spheres may be then withdrawn from the oil bath and typically subjected to specific aging treatments in oil and an ammonia solution to further improve their physical characteristics. One exemplary oil dropping method is disclosed in U.S. Pat. No. 2,620,314.

Preferably, the resulting composite is then washed and dried at a relatively low temperature of about 50- about 200° C. and subjected to a calcination procedure at a temperature of about 450- about 700° C. for a period of about 1- about 20 hours.

Generally, the catalyst also includes a noble metal, including one or more elements of platinum, palladium, rhodium, ruthenium, osmium, and iridium. The preferred noble metal is platinum. The noble metal may exist within the catalyst as a compound such as an oxide, a sulfide, a halide, or an oxysulfide; as an elemental metal; or as a combination with one or more other ingredients of the catalyst. Desirably, the noble metal exists in a reduced state as an elemental metal. Although the noble metal may be present in the final catalyst in any catalytically effective amount, typically the noble metal will comprise about 0.01- about 2%, preferably about 0.05- about 1%, by weight of the final catalyst, calculated on an elemental basis.

An IUPAC 14 metal may also be incorporated into the catalyst. Of the IUPAC 14 metals, germanium and tin are preferred. The IUPAC 14 metal may be present as an elemental metal; as a chemical compound such as an oxide, a sulfide, a halide, or an oxychloride; or as a physical or chemical combination with the porous carrier material and/or other components of the catalyst. Preferably, a substantial portion of the IUPAC 14 metal exists in a finished catalyst in an oxidation state above that of the elemental metal. Generally, the IUPAC 14 metal is present in an amount of about 0.01- about 5%, by weight, preferably about 0.1- about 2%, by weight, calculated on an elemental basis. The noble metal and IUPAC 14 metal may be incorporated into the catalyst in any suitable manner, such as disclosed in US 2005/0277796.

The catalyst may contain other additional metal components, such as rhenium, cobalt, nickel, indium, gallium, zinc, uranium, dysprosium, thallium, or a mixture thereof. A catalytically effective amount of such a metal component may be incorporated into the catalyst by any means known in the art to effect a homogeneous or stratified distribution.

The catalyst may contain a halogen component, such as fluorine, chlorine, bromine, iodine, or a mixture thereof, with chlorine being preferred. Desirably, however, the catalyst contains no added halogen other than that associated with other catalyst components. The elemental analysis of the catalyst components can be determined by Inductively Coupled Plasma (ICP) analysis. Particularly, some components, such as the noble metal, can be measured by UOP Method 873-86 and other components, such as zeolite or binder where each may contain silica, can be measured by UOP Method 961-98.

Generally, the catalyst is dried, calcined, and reduced according to any suitable method, including those disclosed in US 2005/0277796. In some cases, the resulting reduced catalyst may also be subjected to presulfiding with, for example, neat H₂S at room temperature to incorporate in the catalyst composite from about 0.05- about 1.0%, by weight, sulfur, calculated on an elemental basis.

The catalyst can be included in a zone to isomerize alkylaromatic hydrocarbons, for example, those of the general formula C₆H(₆₋ₙ)Rₙ, where n is an integer from 2-5 and R is CH₃, C₂H₅, C₃H₇, or C₄H₉, in any combination including all the isomers thereof. Suitable alkylaromatic hydrocarbons may include, for example, an ortho-xylene, a meta-xylene, a para-xylene, an ethylbenzene, an ethyltoluene, a tri-methylbenzene, a di-ethylbenzene, a tri-ethyl-benzene, a methylpropylbenzene, an ethylpropylbenzene, a di-isopropylbenzene, or a mixture thereof.

One desired application of the catalyst is the isomerization of a C8 aromatic mixture containing ethylbenzene and one or more xylenes. Generally the mixture has an ethylbenzene content of about 1- about 50%, by weight, an ortho-xylene content of about 0- about 35%, by weight, a meta-xylene content of about 20- about 95%, by weight, and a para-xylene content of about 0- about 30%, by weight. A non-equilibrium mixture of at least one C8 aromatic isomer is present in a concentration that can differ substantially from the equilibrium concentration at isomerization conditions. Usually, the non-equilibrium mixture is prepared by removal of para-, ortho- and/or meta-xylene from a fresh C8 aromatic mixture obtained from an aromatic production process.

The alkylaromatic hydrocarbons may be found in an appropriate fraction from various refinery petroleum streams, e.g., as individual components or as certain boiling-range fractions obtained by the selective fractionation and distillation of catalytically cracked or reformed hydrocarbons. Concentration of the isomerizable aromatic hydrocarbons may be optional. A C8 aromatics feed may contain nonaromatic hydrocarbons, i.e., naphthenes and paraffins, in an amount up to about 30%, by weight. Preferably the isomerizable hydrocarbons consist essentially of aromatics.

Generally, a catalyst is utilized until it is spent. At that time the catalyst can be regenerated to remove carbonaceous deposits. Any amount of carbon may be present on the catalyst, but generally the amount of carbon can be up to about 5%, by weight, desirably up to about 3%, by weight, and optimally up to about 2.5%, by weight based on the weight of the catalyst.

The regeneration process generally entails one or more stages, preferably two stages, of contacting the catalyst with an oxidizing gas. Typically, the oxidizing gas is air. The contacting for both stages can be conducted in an atmosphere including an inert gas, such as nitrogen, and the oxidizing gas. The atmosphere can generally include about 1- about 20 mole percent, preferably 2-15 mole percent, of oxygen. The oxygen content can be varied during the stage depending on a temperature of an exotherm. The stages can be conducted in the presence of water or steam, such as up to about 5.0 mole percent, preferably about 2.5 mole percent, steam at 101.325 kPa. Although water is usually undesired component in a regeneration process, typically a commercial unit may have a partial pressure of, e.g., 3 kPa, of water in a pressurized burn. Furthermore, the stages can also be conducted in the presence of halogen, such as chloride. The halogen can be present in amount of about 10:1- about 250:1 water:C1 mole ratio, preferably about 40:1- about 225:1.

The first stage oxidation can be conducted at a temperature of about 245- about 500° C., desirably about 245- about 400° C., and optimally about 270- about 390° C. for a selected first time period of about 0.5- about 3 days, preferably about 0.5- about 1.5 days. The second stage oxidation can be conducted at temperature of about 350- about 500° C., preferably about 350- about 400° C. for a selected second time period of about 0.5- about 3 days, preferably about 0.5- about 1.5 days. Typically the temperature and/or time period of the first stage oxidation is different than the respective temperature and/or time period of the second stage oxidation. Preferably, the initial temperature of the first stage oxidation is lower than the second stage oxidation. Generally, the time periods of the first and second oxidation stages are of sufficient length so no significant amount of oxidizing gas is reacted at the end of the respective stage. Afterwards, the oxidized catalyst can be contacted with a reducing agent, such as hydrogen, in an atmosphere including up to about 100 mole percent hydrogen. The conditions can include a temperature of about 200- about 650° C., preferably about 400- about 450° C. Furthermore, the catalyst can be cold sulfided with neat H₂S at room temperature to incorporate in the catalyst from about 0.05- about 1.0%, by weight, sulfur calculated on an elemental basis to replace sulfur on the platinum.

Accordingly, such a C8 aromatic mixture can be contacted with the regenerated catalyst in an alkylaromatic hydrocarbon isomerization zone, such as disclosed in US 2005/0277796, for isomerizing, e.g., ethylbenzene into one or more xylenes.

### Illustrative Embodiments

The following examples are intended to further illustrate the one or more embodiments disclosed above. These illustrations of embodiments of the invention are not meant to limit the claims of this invention to the particular details of these examples. These examples are based on engineering calculations and actual operating experience with similar processes.

### EXAMPLE 1

An oil-dropped sphere catalyst contains 0.32%, by weight, platinum; 5%, by weight, MTW zeolite; and the remainder, by weight, alumina. This catalyst is subjected to an isomerization process to accumulate 2.5%, by weight, carbon.

The spent catalyst is sandwiched between an effective amount of a top layer of alumina-supported platinum catalyst spheres and a bottom layer of gamma-alumina spheres. The top layer catalyzes HCl and air to chlorine gas and water that may pass through the spent catalyst. The spent catalyst is regenerated with two burn stages.

The first burn stage is conducted at an initial temperature of about 355° C. for 28 hours in an atmosphere containing 2.4%, by mole, steam at 101.325 kPa and a water:chloride mole ratio of 222:1. The atmosphere can contain about 2%, by mole, oxygen for the first 24 hours and about 15%, by mole, oxygen for the last 4 hours. The maximum bed temperature is about 396° C. The air flow is stopped if the exotherm exceeds a delta of 35° C. (a temperature of 390° C.) and restarted once the temperature falls to a delta of 13° C. (a temperature of 368° C.).

Specifically, the bed is purged with nitrogen at 1150 cc/minute for 15 minutes at room temperature. Next, the bed is ramped at 2° C./minute to 150° C. and held for 0.5 hours at that temperature. Afterwards, the temperature is ramped at 2° C./minute to 355° C. and held to stabilize the temperature before introducing air. Air at 125 cc/minute and a 0.25 M HCl solution at a delivery rate of 1.4 cc/hour can be introduced with the air introduction being stopped and started depending on the exotherm temperature, as discussed above. These parameters are maintained for 24 hours. Afterwards, the air is increased to 920 cc/minute and nitrogen is decreased to 355 cc/minute and held for 3.5 hours. Next, the HCl injection is stopped and the temperature is maintained at 355° C. for 0.5 hours. That being done, the catalyst is cooled with air and nitrogen to room temperature.

The second burn stage is conducted at an initial temperature of about 370° C. for 28 hours in an atmosphere containing 2.4%, by mole, steam at 101.325 kPa and a water:chloride mole ratio of 222:1. The atmosphere can contain about 2%, by mole, oxygen for the first 24 hours and about 15%, by mole, oxygen for the last 4 hours. The air flow is stopped if the exotherm exceeds a delta of 35° C. (a temperature of 405° C.) and restarted once the temperature falls to a delta of 13° C. (a temperature of 383° C.).

Specifically, the bed is purged, if desired, with nitrogen at 1150 cc/minute for 15 minutes at room temperature. Next, the bed is ramped at 2° C./minute to 150° C. and held for 0.5 hours at that temperature. Afterwards, the temperature is ramped at 2° C./minute to 370° C. and held to stabilize the temperature before introducing air. Air at 125 cc/minute and a 0.25 M HCl solution at a delivery rate of 1.4 cc/hour can be introduced with the air introduction being stopped and started depending on the exotherm temperature, as discussed above. These parameters are maintained for 24 hours. Afterwards, the air is increased to 920 cc/minute and nitrogen is decreased to 355 cc/minute and held for 3.5 hours. Next, the HCl injection is stopped and the temperature is maintained at 355° C. for 0.5 hours. That being done, the catalyst is cooled with air and nitrogen to room temperature.

After the two burn stages, the catalyst is reduced in an atmosphere of 100%, by mole, hydrogen for two hours at 425° C. The catalyst has 0.5%, by weight, carbon remaining as measured after reduction. Next, the catalyst is cold-sulfided to 0.05%, by weight, sulfur.

At the same weight hourly space velocity (may be referred to as WHSV), reaction severity and temperature in a screening evaluation, the regenerated catalyst is about 20% less active for isomerizing than fresh catalyst. This lower isomerization activity is unexpected because xylene isomerization activity generally increases after regeneration. In addition, the ethylbenzene isomerization activity and C8 ring loss are substantially the same as fresh catalyst. The “C8 ring loss” is the loss of C8 rings, in mole or weight percent, that can be converted into a desired C8 aromatic. This example suggests that the milder conditions and/or presence of a higher residual carbon level on the catalyst can prevent the increased activity that typically occurs.

### EXAMPLE 2

A trilobe extrudate catalyst contains 0.3%, by weight, platinum; 8%, by weight, MTW zeolite; and the remainder, by weight, alumina. This catalyst is subjected to an isomerization process to accumulate 2.9%, by weight, carbon.

The spent catalyst is sandwiched between a top layer of an effective amount of alumina-supported platinum catalyst spheres and a bottom layer of gamma-alumina spheres. The spent catalyst is regenerated with two burn stages.

The first burn stage is conducted at an initial temperature of about 355° C. for about 26- about 28 hours in an atmosphere containing 2.4%, by mole, steam at 101.325 kPa and a water:chloride mole ratio of 40:1. The atmosphere can contain about 2%, by mole, oxygen for the first 24 hours and about 15%, by mole, oxygen for the last 4 hours. The maximum bed temperature is about 384° C. The air flow is stopped if the exotherm exceeds a delta of 15° C. (a temperature of 370° C.) and restarted once the temperature falls to a delta of 7° C. (a temperature of 362° C.).

Specifically, the bed is purged with nitrogen at 1150 cc/minute for 15 minutes at room temperature. Next, the bed is ramped at 2° C./minute to 150° C. and held for 0.5 hours at that temperature. Afterwards, the temperature is ramped at 2° C./minute to 355° C. and held to stabilize the temperature before introducing air. Air at 125 cc/minute and a 1.4 M HCl solution at a delivery rate of 1.4 cc/hour can be introduced with the air introduction being stopped and started depending on the exotherm temperature, as discussed above. These parameters are maintained for about 22- about 24 hours. Afterwards, the air is increased to 920 cc/minute and nitrogen is decreased to 355 cc/minute and held for 3.5 hours. Next, the HCl injection is stopped and the temperature is maintained at 355° C. for 0.5 hours. That being done, the catalyst is cooled with air and nitrogen to room temperature.

The second burn stage is conducted at an initial temperature of about 370° C. for 28 hours in an atmosphere containing 2.4%, by mole, steam at 101.325 kPa and a water:chloride mole ratio of 222:1. The atmosphere can contain about 2%, by mole, oxygen for the first 24 hours and about 15%, by mole, oxygen for the last 4 hours. The maximum bed temperature is about 381° C. The air flow is stopped if the exotherm exceeds a delta of 15° C. (a temperature of 385° C.) and restarted once the temperature falls to a delta of 7° C. (a temperature of 377° C.).

Specifically, the bed is purged, if desired, with nitrogen at 1150 cc/minute for 15 minutes at room temperature. Next, the bed is ramped at 2° C./minute to 150° C. and held for 0.5 hours at that temperature. Afterwards, the temperature is ramped at 2° C./minute to 370° C. and held to stabilize the temperature before introducing air. Air at 125 cc/minute and a 0.25 M HCl solution at a delivery rate of 1.4 cc/hour can be introduced with the air introduction being stopped and started depending on the exotherm temperature, as discussed above. These parameters are maintained for 24 hours. Afterwards, the air is increased to 920 cc/minute and nitrogen is decreased to 355 cc/minute and held for 3.5 hours. Next, the HCl injection is stopped and the temperature is maintained at 355° C. for 0.5 hours. That being done, the catalyst is cooled with air and nitrogen to room temperature. The catalyst has 0.25%, by weight, carbon remaining as measured after oxidation.

After the two burn stages, the catalyst is reduced in an atmosphere of 100%, by mole, hydrogen for two hours at 425° C. Next, the catalyst is cold-sulfided to 0.05%, by weight, sulfur.

At the same temperature, reaction severity, and three separate WHSV conditions, all aspects of the regenerated catalyst, including xylene and isomerization activity and C8 ring loss are substantially the same as fresh catalyst. This result suggests that the milder conditions and/or presence of a higher residual carbon level on the catalyst may prevent an increase in isomerization activity that typically occurs.

### EXAMPLE 3

A trilobe extrudate catalyst contains 0.3%, by weight, platinum; 5%, by weight, MTW zeolite; and the remainder, by weight, alumina. This catalyst is divided into two portions. The first portion accounting for 25% of the total catalyst weight is subjected to a single isomerization process and regeneration cycle to accumulate 1.1%, by weight, carbon. The second portion accounting for 75% of the total catalyst weight is subjected to a second isomerization process and regeneration cycle, after an initial isomerization process cycle and subsequent regeneration to accumulate 4.1%, by weight, carbon.

The catalyst portions are separated into separate layers in a four-layer regeneration bed. The regeneration bed has a top layer of an effective amount of alumina-supported platinum catalyst spheres, a second layer of the second catalyst portion, a third layer of the first catalyst portion, and a bottom layer of gamma-alumina spheres. Three sheets of quartz wool separate adjacent layers, namely a first sheet is between the top and second layers, a second sheet is between the second and third layers, and a third sheet is between the third and fourth layers. The spent catalyst including the first and second portions is regenerated with two burn stages.

The first burn stage is conducted at an initial temperature of about 355° C. for 28 hours in an atmosphere containing 2.4%, by mole, steam at 101.325 kPa and a water:chloride mole ratio of 40:1. The atmosphere can contain about 2%, by mole, oxygen for the first 24 hours and about 15%, by mole, oxygen for the last 4 hours. The maximum bed temperature is about 384° C. The air flow is stopped if the exotherm exceeds a delta of 15° C. (a temperature of 370° C.) and restarted once the temperature falls to a delta of 7° C. (a temperature of 362° C.).

Specifically, the bed is purged with nitrogen at 1150 cc/minute for 15 minutes at room temperature. Next, the bed is ramped at 2° C./minute to 150° C. and held for 0.5 hours at that temperature. Afterwards, the temperature is ramped at 2° C./minute to 355° C. and held to stabilize the temperature before introducing air. Air at 125 cc/minute and a 1.4 M HCl solution at a delivery rate of 1.4 cc/hour can be introduced with the air introduction being stopped and started depending on the exotherm temperature, as discussed above. These parameters are maintained for 24 hours. Afterwards, the air is increased to 920 cc/minute and nitrogen is decreased to 355 cc/minute and held for 3.5 hours. Next, the HCl injection is stopped and the temperature is maintained at 355° C. for 0.5 hours. That being done, the catalyst is cooled with air and nitrogen to room temperature.

The second burn stage is conducted at an initial temperature of about 370° C. for 28 hours in an atmosphere containing 2.4%, by mole, steam at 101.325 kPa and a water:chloride mole ratio of 222:1. The atmosphere can contain about 2%, by mole, oxygen for the first 24 hours and about 15%, by mole, oxygen for the last 4 hours. The maximum bed temperature is about 377° C. The air flow is stopped if the exotherm exceeds a delta of 15° C. (a temperature of 385° C.) and restarted once the temperature falls to a delta of 7° C. (a temperature of 377° C.).

Specifically, the bed is purged, if desired, with nitrogen at 1150 cc/minute for 15 minutes at room temperature. Next, the bed is ramped at 2° C./minute to 150° C. and held for 0.5 hours at that temperature. Afterwards, the temperature is ramped at 2° C./minute to 370° C. and held to stabilize the temperature before introducing air. Air at 125 cc/minute and a 0.25 M HCl solution at a delivery rate of 1.4 cc/hour can be introduced with the air introduction being stopped and started depending on the exotherm temperature, as discussed above. These parameters are maintained for 24 hours, except the delivery of water and HCl solution can be stopped for about 12 hours. Afterwards, the air is increased to 920 cc/minute and nitrogen is decreased to 355 cc/minute and held for 3.5 hours. Next, the HCl injection is stopped and the temperature is maintained at 355° C. for 0.5 hours. That being done, the catalyst is cooled with air and nitrogen to room temperature. The first portion of catalyst has 0.08%, by weight, carbon and the second portion of catalyst has 0.14%, by weight, carbon remaining as measured after oxidation.

After the two burn stages, the catalyst portions are separately reduced in an atmosphere of 100%, by mole, hydrogen for two hours at 425° C., and cold-sulfided to 0.05%, by weight, sulfur. After sulfiding, the first and second portions are combined for testing activity and C8 ring loss.

At the same temperature, reaction severity, and WHSV condition, all aspects of the regenerated catalyst, including xylene and isomerization activity and C8 ring loss, are substantially the same as fresh catalyst. This result suggests that the milder conditions and/or presence of a higher residual carbon level on the catalyst may prevent the increase in isomerization activity that typically occurs.

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

All the UOP methods, such as UOP-703-98, UOP-873-86, and UOP-961-98, discussed herein can be obtained through ASTM International, 100 Barr Harbor Drive, West Conshohocken, Pa., USA.

In the foregoing, all temperatures are set forth uncorrected in degrees Celsius and, all parts and percentages are by weight, unless otherwise indicated.

From the foregoing description, one skilled in the art can easily ascertain the essential characteristics of this invention and, without departing from the spirit and scope thereof, can make various changes and modifications of the invention to adapt it to various usages and conditions.

1. A regeneration process for a C8 alkylaromatic isomerization catalyst, comprising:
A) contacting the C8 alkylaromatic isomerization catalyst with a first gas stream comprising an oxidizing gas at a first stage for a first time period and a first temperature effective to remove at least a portion of a carbonaceous material from the C8 alkylaromatic isomerization catalyst; and
B) contacting the C8 alkylaromatic isomerization catalyst with a second gas stream comprising the oxidizing gas at a second stage for a second time period and a second temperature effective to remove another portion of the carbonaceous material from the C8 alkylaromatic isomerization catalyst;
1) wherein the C8 alkylaromatic isomerization catalyst comprises:
a) about 1- about 90%, by weight, of a molecular sieve wherein the molecular sieve comprises at least one of an MTW zeolite, an MFI zeolite, a mordenite zeolite and an ATO non-zeolite sieve wherein each zeolite has a silica to alumina mole ratio less than about 45:1;
b) about 10- about 99%, by weight, of a binder; and
c) about 0.1- about 2%, by weight, of a noble metal, calculated on an elemental basis.

2. The regeneration process according to claim 1, further comprising controlling an exotherm during at least one of the first and second stages by regulating an amount of the oxidizing gas.

3. The regeneration process according to claim 1, further comprising cooling the C8 alkylaromatic isomerization catalyst after the first stage.

4. The regeneration process according to claim 1, wherein the first time period is about 0.5- about 3 days and the first temperature is about 245- about 500° Celsius.

5. The regeneration process according to claim 1, wherein the second time period is about 0.5- about 3 days and the second temperature is about 350- about 500° Celsius.

6. The regeneration process according to claim 1, wherein the first time period is about 0.5- about 3 days and the first temperature is about 270- about 390° Celsius.

7. The regeneration process according to claim 1, wherein the first and second gas streams comprise oxygen and nitrogen.

8. The regeneration process according to claim 7, further comprising:
controlling an amount of oxygen in at least one of the first and second gas streams based on the temperature of the stage.

9. The regeneration process according to claim 1, further comprising reducing the C8 alkylaromatic isomerization catalyst after the second stage.

10. The regeneration process according to claim 9, further comprising sulfiding the reduced C8 alkylaromatic isomerization catalyst.

11. The regeneration process according to claim 1, wherein the C8 alkylaromatic isomerization catalyst further comprises a halogen material.

12. The regeneration process according to claim 1, wherein the C8 alkylaromatic isomerization catalyst further comprises:
about 0.01- about 5%, by weight, of a Group IVA metal, calculated on an elemental basis.

13. The regeneration process according to claim 1, wherein the binder comprises at least one of a refractory inorganic oxide, a ceramic, a porcelain, a bauxite, a silica, a silica gel, a silicon carbide, a clay, a silicate, a crystalline zeolitic aluminosilicate, an aluminophosphate and a spinel.

14. The regeneration process according to claim 1, further comprising injecting a halogen material effective to aid the dispersion of the noble metal.

15. The regeneration process according to claim 1, wherein at least one of the first and second stages are maintained until no significant amount of the oxidizing gas is reacted during contacting.

16. The regeneration process according to claim 1, wherein the regeneration process removes about 75% - about 95%, by weight of a total amount of the carbonaceous material.

17. A regeneration process for a C8 alkylaromatic isomerization catalyst, comprising:
A) contacting the C8 alkylaromatic isomerization catalyst with a first gas stream comprising an oxidizing gas at a first stage at a temperature of about 245- about 500° C. effective to remove at least a portion of the carbonaceous material from the C8 alkylaromatic isomerization catalyst;
B) contacting the C8 alkylaromatic isomerization catalyst with a second gas stream comprising the oxidizing gas at a second stage at a temperature of about 350- about 500° C. effective to remove another portion of the carbonaceous material from the C8 alkylaromatic isomerization catalyst; and
C) removing a total amount of at least about 75%, by weight, of the carbonaceous material;
1) wherein the C8 alkylaromatic isomerization catalyst comprises:
a) about 1- about 90%, by weight, of at least one of an MTW zeolite, an MFI zeolite, a mordenite zeolite, and an MgAPSO-31 non-zeolite molecular sieve wherein each zeolite has a silica to alumina mole ratio less than about 45:1;
b) about 10- about 99%, by weight, of a binder; and
c) about 0.1- about 2%, by weight, of a noble metal, calculated on an elemental basis.

18. The regeneration process according to claim 17, further comprising controlling an exotherm during at least one of the first and second stages by regulating the amount of the oxidizing gas.

19. The regeneration process according to claim 17, further comprising reducing the C8 alkylaromatic isomerization catalyst after the second stage.

20. A regeneration process for a C8 alkylaromatic isomerization catalyst, comprising:
A) contacting the C8 alkylaromatic isomerization catalyst with a first gas stream comprising an oxidizing gas at a first stage at a temperature of about 245- about 500° C. effective to remove at least a portion of a carbonaceous material from the C8 alkylaromatic isomerization catalyst;
B) contacting the C8 alkylaromatic isomerization catalyst with a second gas stream comprising the oxidizing gas at a second stage at a temperature of about 350- about 500° C. effective to remove another portion of the carbonaceous material from the C8 alkylaromatic isomerization catalyst;
C) reducing the C8 alkylaromatic isomerization catalyst; and
D) sulfiding the C8 alkylaromatic isomerization catalyst;
1) wherein the C8 alkylaromatic isomerization catalyst comprises:
a) about 1- about 90%, by weight, of at least one of an MTW zeolite, an MFI zeolite, a mordenite zeolite, and an ATO non-zeolite sieve wherein each zeolite has a silica to alumina mole ratio less than about 45:1;
b) about 10- about 99%, by weight, of a binder; and
c) about 0.1- about 2%, by weight, of a noble metal, calculated on an elemental basis.
